(19) United States
(12) Patent Application Publication
(10) Pub. No.: US 2019/0047522 A1
(43) Pub. Date: Feb. 14, 2019

(54) SYSTEM AND METHOD FOR CONTROLLING A DEVICE FOR CLEANING A WINDOW OF A VEHICLE

(71) Applicant: Valeo Systèmes d'Essuyage, Le Mesnil Saint Denis (FR)

(72) Inventors: Frédéric Giraud, Le Mesnil Saint Denis (FR); Denis Thebault, Issoire (FR)

(73) Assignee: Valeo Systèmes d'Essuyage, Le Mesnil Saint Denis (FR)

(21) Appl. No.: 16/076,829

(22) PCT Filed: Feb. 7, 2017
(86) PCT No.: PCT/EP2017/052650

§ 371 Date: Aug. 9, 2018

(30) Foreign Application Priority Data
Feb. 11, 2016 (FR) 1651091

(51) Int. Cl. B60S 1/48; B60S 1/52

(52) U.S. Cl. CPC B60S 1/485; B60S 1/488; B60S 1/524

(57) ABSTRACT

The invention relates to a system for controlling a device (1) for cleaning a vehicle window (2), said device (1) being arranged to perform a first cleaning function, suitable for example for standard cleaning of dust, and at least one second cleaning function, intended for clearing the window (2) of a specific material, in particular frost, snow or insects, adhering to the outer surface of said window, comprising at least one sensor (19) arranged to provide information on the presence of said material on at least one portion of the outer surface of the window (2) and a first electronic means (20) arranged to receive commands for executing functions of the cleaning device (1) and communicating with the latter, characterised in that it is arranged so that the first electronic means (20) responds to a first command for executing the second function by performing, with the data of said at least one sensor (19), an identification of the presence or the absence of said material and not activating the second function if it identifies the absence of said material. The invention also relates to a method using said system.

### TECHNICAL FIELD

The technical sector for the present invention is that of the methods for de-icing and/or cleaning a window of a vehicle, in particular a motor vehicle, and of the corresponding devices using windscreen wipers and liquid spraying means.

### STATE OF THE ART

Motor vehicles are routinely equipped with systems for wiping and washing windows to ensure a wiping and a washing of the windows and thus avoid having the view that the driver has of his or her environment disrupted. Such an installation generally comprises two windscreen wipers which scrape the outer surface of the window, such as the windshield, so as to dispel the water present on this surface. Spray nozzles are positioned on the hood of the vehicle or, in a more recent version, on the wipers, and are supplied with windscreen washing liquid via a pump and a system of pipelines linked to a windscreen washing liquid tank.

Some motor vehicles are equipped with de-icing systems. A de-icing system generally comprises a conventional wiping and washing system of the abovementioned type, and, in addition, comprises a tank of de-icing liquid and even an additional pump. In order to de-ice a window in cold weather, the spray nozzles are supplied with de-icing liquid via the pump and the system of pipelines linked to the de-icing liquid tank.

This device can also be used, with the same type of liquid or a different liquid, to remove the smears caused by the crushing of mosquitoes or other insects against the windshield. The liquid is then used to dissolve and/or remove these smears before the wiper scrapes the windshield to dispel them.

The Applicant has already proposed de-icing systems and devices, described in particular in the document FR-A1-2 789 034, which use electronically-controlled motors, for example operating in stepper mode, capable of performing a sweep of the windshield by successive angular segments, with stops and by modulating the sweep speed.

With the use of this technology, it is possible to define de-icing programs in which, in particular, the climb of the wipers over the window is performed in a series of successive angular steps with spraying of de-icing liquid, allowing time for the liquid to act to ensure an excellent recovery of visibility for outside temperatures dropping at least to −20° C.

However, both for the de-icing function and for the insect cleaning function, the implementation of such programs increases the consumption of a relatively costly liquid, more expensive than a normal cleaning liquid. It is therefore essential to avoid using this function when it is not necessary, in particular when there is no ice or smearing, or the little which is deposited can be eliminated by a cleaning cycle with a normal liquid. Furthermore, if the conditions are too severe, too much ice for example, the device will be ineffective and the liquid will be expended as a pure loss.

There is therefore a need to monitor the usefulness of launching the de-icing and/or insect cleaning method, so as to launch it only when useful. The problem has been explained by taking for its example a device using a special liquid for the de-icing. However, the need also exists for a device using other means for de-icing, for example electric heating means. In this case, the aim is also to save on the resources which are used by the de-icing function.

The invention provides a solution to this need, suitable for all the vehicles that have a window cleaning device comprising a de-icing and/or insect cleaning function.

### SUMMARY OF THE INVENTION

To this end, the invention relates to a system for controlling a device for cleaning a vehicle window, said device being arranged to perform a first cleaning function, suitable for example for a standard cleaning of dust, and at least one second cleaning function, intended for clearing the window of a determined material, in particular of ice, snow or insects, adhering to the outer surface of said window, comprising at least one sensor arranged to provide information on the presence of said material on at least one of the outer surface of the window and a first electronic means arranged to transmit commands for the execution of the functions of the cleaning device and communicate with the latter, characterized in that it is arranged so that the first electronic means transmits a first command for execution of the second function by performing, with the data of said at least one sensor, an identification of the presence or of the absence of said material and not activating the second function if it identifies the absence of said material.

The user can actuate the second function remotely and therefore, not seeing the state of the window, request the execution thereof even though it is pointless. In particular, if the second function uses particular resources, such as a special liquid, the latter will be expended pointlessly. By virtue of the invention, by using the information on the presence of the material adhering to the window to block the execution of the second function, the control system makes it possible to avoid an untimely activation of the second function and to save on the particular resources that it uses.

Advantageously, the system further comprises a second electronic means connected to the first electronic means and arranged to communicate with a portable terminal, so as to receive commands from a user situated at a distance from the vehicle, and to transmit information to said user.

Preferentially, the system is arranged to transmit to the portable terminal a message informing on the absence of said material when the first electronic means has identified the absence of said material.

Advantageously, the system is arranged to activate the second function when it receives a second execution command, coming in particular from the user, after having sent the message informing on the absence of said material. The user can thus take back control and have the second function executed even so if he or she is convinced of its usefulness.

Said at least one sensor can be a camera placed inside the vehicle, whose field of view crosses at least a part of the window.

The system can, in addition, be arranged so that the first electronic means, after having identified the presence of said material, checks, with the data of said at least one sensor, that the quantity of said material present on the outer surface of the window is not too great for the execution of the second function by the cleaning device and does not activate the second function if the quantity of said material is greater than a predetermined threshold value. In this way, the control system makes it possible to avoid using the resources implemented by the second function if the device is not capable of correctly eliminating said material. That can also make it possible to preserve the cleaning device if, for example, there is too much ice to unstick the wipers.

Advantageously, said at least one sensor and the first electronic means are arranged to provide a quantitative assessment of said material deposited on the outer surface of the window.

When said material is ice or snow, said at least one sensor and the first electronic means can be arranged to assess an estimation of the thickness of ice or of snow, for example by performing a measurement of opacity through the window.

In this case, the system can be arranged to control the cleaning device by using the estimation of the thickness of ice or of snow to adapt operating parameters of the second function. The operating parameters can in particular include a suitable control of the displacement of the windscreen wipers and/or of the liquid spraying strategy.

The invention relates also to an assembly comprising a system as has been described, and a device for cleaning a vehicle window arranged to perform a first cleaning function, suitable for example for a standard cleaning of dust, and at least one second cleaning function, intended for clearing the window of a determined material, in particular ice, snow or insects, adhering to the outer surface of said window.

The cleaning device can comprise specific means, using for example a liquid, arranged to be activated by the second function and not be activated by the first function.

The invention relates also to a method for controlling a device for cleaning a vehicle window, said device being arranged to perform a first cleaning function, suitable for example for a standard cleaning of dust, and at least one second cleaning function, intended for clearing the window of a determined material, in particular ice, snow or insects, adhering to the outer surface of said window, characterized in that it comprises, after a first command sent by a user to execute said second function:
a first step, of acquisition, comprising at least one taking of information on the presence of said material on at least a portion of the outer surface of the window;
a second step, of checking, in which the information from the first step is used to identify the presence or the absence of said material on the outer surface of the window and a result of which is to not activate the second function if the absence of said material is identified.

Advantageously, the method comprises, in addition, a third step in which the information on the absence of said material is communicated to the user when the second function is not activated at the end of the second step, and in which the second function is launched if a second command is sent by the user to execute said second function.

The method can comprise, after following the second step, when the presence of said material has been identified, a fourth step in which an additional analysis of the quantity of material present on the outer surface of the window, to determine whether the quantity of said material present on the outer surface of the window is not too great for the execution of the second function by the cleaning device and which does not activate the second function if the quantity of said material is greater than a predetermined threshold value.

The fourth step can provide an estimation of the quantity of said material and the method can comprise a fifth step in which this information is communicated to the user.

### DESCRIPTION OF THE FIGURES

Other features and advantages of the invention will become apparent on reading of the following description and of exemplary embodiments given by way of illustration with reference to the attached figures. In these figures:

FIG. 1 is a schematic view of a device for cleaning a window, here of a motor vehicle;

FIG. 2 is a schematic view of an assembly comprising a control system according to the invention and the cleaning device of FIG. 1; and

FIG. 3 is a diagram illustrating the steps of a control method according to the invention for the cleaning device of FIG. 1.

### DETAILED DESCRIPTION

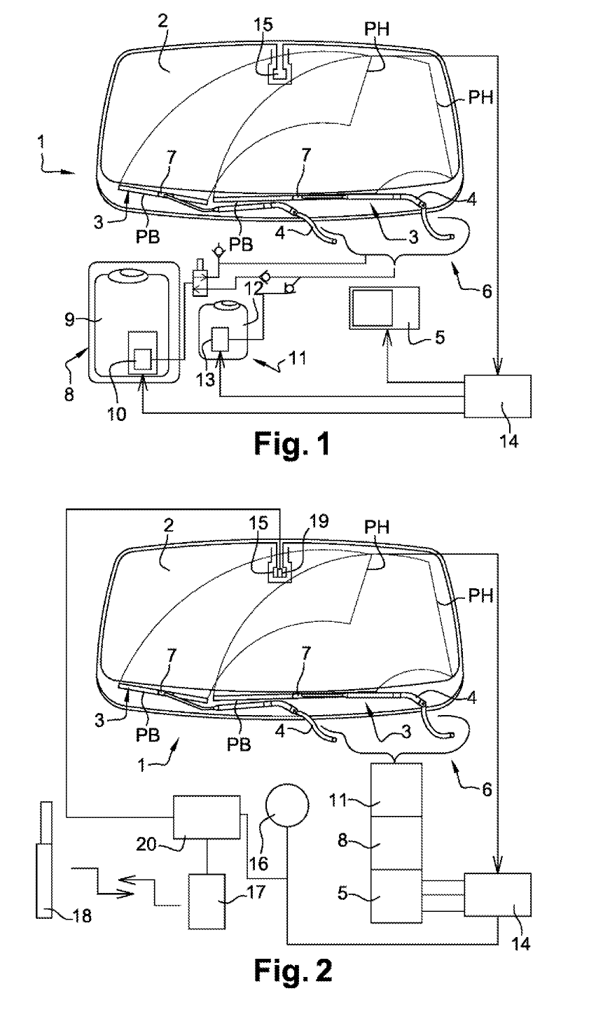

The invention relates to the control of a cleaning device 1 applied for example to a window of a motor vehicle, such as a windshield 2, as illustrated in FIG. 1.

The cleaning device 1 comprises at least one windscreen wiper 3 mounted on an arm 4 and capable of being displaced over the windshield 2 between a low position PB and a high position PH, and vice versa. In the example represented, the device 1 comprises two windscreen wipers 3. The cleaning device 1 also comprises a motor 5 intended to drive the windscreen wipers between their respective low positions PB and high positions PH.

The cleaning device 1 also comprises a set of means for spraying liquid onto the windshield. In this example, a system of pipelines 6 is linked to spray nozzles 7 intended to spray liquid onto the windshield. The spray nozzles 7 are, here, situated all along the windscreen wipers 3. They are arranged so as to spray liquid upward from the windscreen wipers 3, that is to say toward the top of the windshield 2. It is also possible for spray nozzles 7 situated on both sides of the windscreen wipers 3 to simultaneously spray the liquid on each side of advance. The system could also be implemented using at least one spray nozzle situated arranged at a longitudinal end of the windscreen wiper, the spraying of liquid then being performed either only in the climbing direction, or only on the side of advance of the wiper.

The pipeline system 6 is supplied with liquid to be sprayed onto the windshield 2 by two distinct upstream circuits according to the function requested of the cleaning device 1.

For a normal washing function, the first circuit 8 comprises a first tank 9 containing a washing liquid and a first pump 10 intended to circulate the washing liquid in the pipeline system 6.

For a de-icing function, the second circuit 11 comprises a second tank 12 containing a de-icing liquid and a second pump 13 intended to circulate the de-icing liquid in the pipeline system 6. This de-icing function is generally used to remove either ice, or snow deposited on the windshield.

Preferably, the cleaning device 1 is arranged to be able also to clean insects stuck onto the windshield 2. Advantageously, the second tank 12 takes the form of a removable cartridge. It is then possible, by changing the cartridge for example, to replace the de-icing liquid with a liquid suitable for cleaning insects, for example a specific detergent. Thus, it is possible, depending on the season for example, to adapt the cleaning device either to the de-icing function or to the insect cleaning function.

The de-icing and insect cleaning functions have the particular feature, compared to the normal washing function, of clearing the windshield of a material adhering to the windshield, for which the liquid used for the normal washing function is unsuited.

The cleaning device 1 described uses a particular liquid to melt the ice and/or the snow in order to remove them from the window 2. Another type of cleaning device can use heating means to melt the ice and/or the snow. In this case, the de-icing function uses additional resources in the form of electrical energy of the vehicle to activate the heating means.

The cleaning device 1 further comprises an electronic unit 14 capable of controlling the motor 5 driving the windscreen wipers 3 and the activation of the pumps 10, 13 of the two circuits 8, 11 supplying liquid to execute on the device 1 cycles suited either to the normal washing function, with the washing liquid present in the first tank 11, or one of the de-icing and/or insect cleaning functions, with the specific liquid present in the second tank 12. The electronic control unit 14 can be more or less simple, depending on the complexity of the operations provided to fulfill the various functions.

Advantageously, the vehicle is also equipped with an outside temperature sensor 15. It is situated here on a top part of the windshield, at the center thereof, without this position being limiting. The sensor 15 can be directly exposed to the ambient air outside the vehicle and is intended to measure the outside temperature, for example within a range of values ranging from −50° C. to +50° C.

In this case, the control unit 14 can be linked to the temperature sensor 15 and use the information from this sensor to adapt the parameters of the functions executed by the device 1.

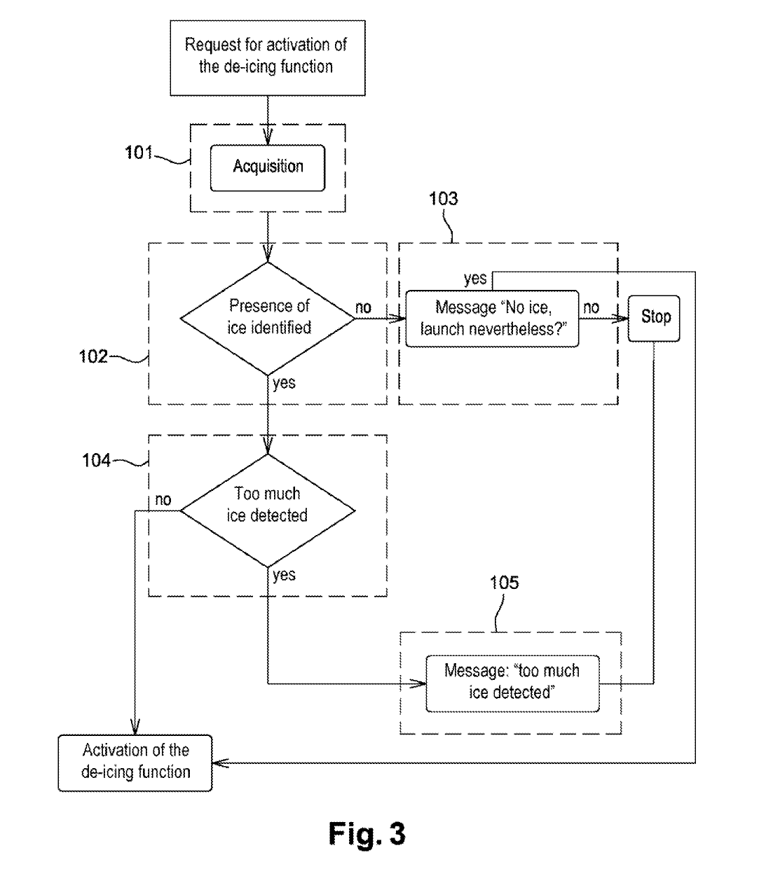

Referring to FIG. 2, the vehicle generally comprises embedded control means 16 which allow a driver to send commands to the control unit to have the various functions executed on the cleaning device 1. Normally, the de-icing and/or insect cleaning functions must be done when the vehicle is stopped. The control means can therefore comprise safety devices for preventing these functions when the vehicle is running.

Here, the vehicle is also equipped with an electronic remote transmission module 17 to allow a user, when the vehicle is parked, to remotely launch the de-icing or insect cleaning functions of the cleaning device 1. This electronic remote transmission module is arranged to communicate with a terminal, which is, for example, a cell phone, on which the user can send commands and/or read messages.

According to the invention, referring to FIG. 2, the vehicle is equipped with a sensor 19 of the outer surface condition of the windshield 2 and an electronic control module 20 arranged to use the information from the sensor 19. The electronic control module 20 can be a specific unit or onboard computer, depending on the type of vehicle. In the example presented in FIG. 2, the electronic control module 20 is also linked to the electronic remote transmission module 17 communicating with the portable terminal 18. Based on the information collected, the electronic control module 20 gives instructions to the control unit 14.

The sensor 19 and the electronic control module 20 are arranged to analyze the outer surface condition of the windshield 2 and deduce therefrom an assessment of the relevance of the activation of the de-icing and/or insect cleaning functions by the cleaning device 1.

In the example illustrated, the sensor 19 is a camera situated inside the vehicle and looking outward through said windshield. This camera 19 is installed so as not to hamper the vision of the driver but also in such a way that its field covers a portion of windshield representative of the surface condition thereof. Here, the camera 19 is installed at the top center of the windshield, generally level with the rear view mirror, and its field covers a portion of the window 2 swept by at least one of the wipers 3.

Variants can be envisaged for the sensor 19, which can be a camera installed outside the vehicle, even an ultrasound sensor on the window 2. The important thing is that the sensor 19 can provide information on the material stuck, ice or crushed insects, on the outer surface of the window 2.

The functionalities of the camera 19 and of the electronic control module 20 are detailed hereinbelow by following the various steps performed with the control system consisting of the sensor 19, the electronic control module 20 and the electronic remote transmission module 17 before sending a de-icing or insect cleaning function activation command to the cleaning device 1.

Referring to the diagram of FIG. 3, the vehicle being stopped, the process is generally started by a request from the user sent using his or her cell phone 18 to the electronic remote transmission module 17. According to a first variant of the control system, he or she can send a targeted command, perform a de-icing or a cleaning of insects, depending on the period of the year, the weather or the previous use of the vehicle. According to a second variant, he or she can send a more general command, of the “proceed with cleaning” type, leaving the control system with the task of launching the correct cleaning device 1 function. The user can be away from his or her vehicle and not see the condition of the window 2, so he or she is not necessarily certain that his or her request is relevant.

The control system starts the process with a first step 101 of acquisition of at least one image by the camera 19, requested by the electronic control module 20. At this stage, several variants are possible. In a first variant, the camera 19 can be focused to infinity. In this case, it provides information on the manner in which the windshield transmits a view of the outside scenes. In another version, it can be focused on the surface of the windshield, and in this case it provides direct information on the surface condition of the windshield. For the rest of the explanation, the first variant will be used.

According to a first aspect of the invention, in a second step 102, the electronic control module 20 uses the image supplied by the camera 19 in order to determine or not the presence of ice, of snow or of insects on the window 2. For that, it can for example use a shape recognition program or the like, depending on the information supplied by the camera. In this analysis, the electronic control module 20 can, for example, discriminate the presence and the absence of material by a given threshold of cleanliness and/or of visibility for a driver through the window 2.

If, at the end of this second step 102, the electronic control module 20 has identified an absence of ice, of snow, or of insects, it concludes that it is not relevant to launch a de-icing or insect cleaning cycle and it does not transmit the command to launch this function to the control unit 14 of the cleaning device 1.

In this case, preferably, the electronic control module 20 launches a third step 103, of communication with the user. In this step, the electronic remote transmission module 17 sends a message indicating that it is not necessary to execute the command, for example, in the case of ice: “no ice”. The information can be accompanied by a request asking the user if he or she nevertheless wants to proceed with the de-icing or insect cleaning. The electronic remote transmission module 17 will then transmit to the control module the command to launch the function if the user responds in the affirmative.

At the end of the second step 102, the electronic control module can, conversely, conclude on the presence of ice or of insects on the window. According to a variant, the control module 20 can confirm its analysis through data external to the sensor 19, for example the outside temperature given by the temperature sensor 15 or information on the type of cartridge installed in the specific liquid tank 12.

If, at the end of the second step 102, the electronic control module 20 has concluded on the relevance of activating the de-icing or insect cleaning function, according to the invention, in a first embodiment, it can, according to a variant not represented, order the control unit 14 to activate the corresponding function of the cleaning device 1 and, possibly, have a message sent to the user indicating that the function is activated.

However, according to another aspect of the invention, illustrated in FIG. 3, the control module 20 can have a fourth step 104 performed on the control system before activating the de-icing or insect cleaning function. The step is described here for controlling the de-icing function. A similar process can be envisaged in the case of the insect cleaning function.

In this step 104, the electronic control module 20 can proceed with an additional analysis of the information supplied by the camera 19. Here, the electronic control module 20 can carry out a more in-depth analysis of the image obtained in the first acquisition step 101. In a variant that is not represented, the step 104 can be preceded by a second step of acquisition, not represented, in which the electronic control module 20 has other measurements taken by the camera 19.

The analyses of the electronic control module 20 in this step 104 are arranged here to characterize a parameter such as the thickness of ice deposited on the window 2, in order to determine whether the cleaning device 1 will be capable of correctly de-icing the window 2. It determines, for example, a degree of opacity of the window 2.

The conclusion of the electronic control module 20 can be binary: there is too much ice to activate the de-icing function or there is not too much thereof. The conclusion can also be more quantitative: if a de-icing cycle may be launched, the thickness deposited on the outer surface of the window may require more or less de-icing liquid and/or more or fewer sweep cycles in the de-icing function.

If, at the end of the fourth step 104, the electronic control module 20 has concluded on the possibility of launching a de-icing cycle without identifying any particular constraint on the quantity of de-icing liquid used, it can directly order the control unit 14 to launch the corresponding cycle and, possibly, have a message sent to the user indicating that the cycle has started.

If, at the end of this fourth step 104, the electronic control module 20 has concluded that there is too much ice for the de-icing function to be performed correctly, it keeps the cleaning device 1 stopped and does not activate the de-icing function. If the electronic control module 20 has generated more quantitative information culminating in the fact that the quantity of ice deposited on the window 2 can be correctly cleaned provided that the cleaning device uses a quantity of liquid greater than a given standard quantity for the de-icing function, it also preferably keeps the cleaning device 1 stopped and does not activate the de-icing function.

Advantageously, in the above two cases, the electronic control module 20 launches a fifth step 105, of communication with the user. In this step, the electronic remote transmission module 17 sends a message giving the information generated by the electronic control module 20.

In the case where the de-icing is possible but requires a large quantity of de-icing liquid, the user can nevertheless decide to proceed with the de-icing. The electronic remote transmission module 17 then transmits the command to activate the de-icing function to the electronic control module 20. In a variant that is not represented, the electronic control module 20 can send to the control unit 14 commands to adapt certain parameters of the de-icing function, such as, for example, the quantity of liquid used.

The operations performed by the control system have been described primarily for the de-icing function. The person skilled in the art will easily be able to adapt these operations to the case where the material adhering to the window 2 corresponds to insects to control the corresponding cleaning function.

1. A system for controlling a device for cleaning a vehicle window, said device being arranged to perform a first cleaning function for a standard cleaning of dust, and at least one second cleaning function for clearing the window of a determined material selected from the group consisting of ice, snow and insects, adhering to the outer surface of said window, the system comprising:
at least one sensor arranged to provide information on the presence of said material on at least one portion of the outer surface of the window; and
a first electronic means arranged to transmit commands for executing functions of the cleaning device and communicating with the latter,
wherein the system is arranged so that the first electronic means transmits a first command for executing the second function by performing, with the data of said at least one sensor, an identification of the presence or of the absence of said material and not activating the second function when the first electronic means identifies the absence of said material.

2. The system as claimed in claim 1, further comprising a second electronic means connected to the first electronic means and arranged to communicate with a portable terminal, so as to receive commands from a user situated at a distance from the vehicle, and to transmit information to said user.

3. The system as claimed in claim 2, arranged to transmit to the portable terminal a message informing on the absence of said material when the first electronic means has identified the absence of said material.

4. The system as claimed in claim 3, arranged to activate the second function when the system receives a second execution command, coming from the user, after having sent the message informing on the absence of said material.

5. The system as claimed in claim 1, wherein said at least one sensor is a camera placed inside the vehicle, whose field of view covers at least a portion of the window.

6. The system as claimed in claim 1, arranged so that, the first electronic means, after having identified the presence of said material, checks, with the data of said at least one sensor, that the quantity of said material present on the outer surface of the window is not too great for the execution of the second function by the cleaning device, and does not activate the second function when the quantity of said material is greater than a predetermined threshold value.

7. The system as claimed in claim 6, in which said at least one sensor and the first electronic means are arranged to provide a quantitative assessment of said material deposited on the outer surface of the window.

8. The system as claimed in claim 7, for which said material is ice or snow, in which said at least one sensor and the first electronic means are arranged to assess an estimation of the thickness of ice or of snow, for example by performing a measurement of opacity through the window.

9. The system as claimed in claim 8, arranged to control the cleaning device by using the estimation of the thickness of ice or of snow to adapt operating parameters of the second function.

10. An assembly comprising a system as claimed in claim 1, and a device for cleaning a vehicle window arranged to perform a first cleaning function, for a standard cleaning of dust, and at least one second cleaning function for clearing the window of a determined material selected from the group consisting of ice, snow and insects, adhering to the outer surface of said window.

11. The assembly as claimed in claim 10, in which the cleaning device comprises specific means, using a liquid for example, arranged to be activated by the second function and not activated by the first function.

12. A method for controlling a device for cleaning a vehicle window, said device being arranged to perform a first cleaning function for a standard cleaning of dust, and at least one second cleaning function for clearing the window of a determined material selected from the group consisting of ice, snow and insects, adhering to the outer surface of said window, the method comprising, after a first command sent by a user to execute said second function:
a first step of acquisition, comprising at least one taking of information on presence of said material on at least a portion of the outer surface of the window; and
a second step of checking, in which the information from the first step is used to identify the presence or the absence of said material on the outer surface of the window and a result of which is to not activate the second function if the absence of said material is identified.

13. The method as claimed in claim 12, further comprising a third step in which the information on the absence of said material is communicated to the user when the second function is not activated at the end of the second step and in which the second function is launched when a second command is sent by the user to execute said second function.

14. The method as claimed in claim 13, comprising, following the second step, when the presence of said material has been identified, a fourth step in which an additional analysis of the quantity of material present on the outer surface of the window, to determine whether the quantity of said material present on the outer surface of the window is not too great for the execution of the second function by the cleaning device and which does not activate the second function when the quantity of said material is greater than a predetermined threshold value.

15. The method as claimed in claim 14, in which the fourth step provides an estimation of the quantity of said material, and further comprising a fifth step in which this information is communicated to the user.
